(19) United States
(12) Patent Application Publication
(10) Pub. No.: US 2002/0021539 A1
(43) Pub. Date: Feb. 21, 2002

(54) Protective circuit against overheating of a semiconductor switching device

(75) Inventors: Shigefumi Odaohhara, Yamato-shi (JP); Hiroshi Nakagawa, Yamato-shi (JP)

Correspondence Address: H. Daniel Schnurmann, Intellectual Property Law IBM Corporation, Dept. 18G, Building 300-482, 2070 Route 52, Hopewell Junction, NY, 12533, US

(73) Assignee: INTERNATIONAL BUSINESS MACHINES CORPORATION, ARMONK, NY (US)

(21) Appl. No.: 09/902,702

(22) Filed: Jul. 11, 2001

(30) Foreign Application Priority Data
Aug. 16, 2000 (JP) 2000-247048

(51) Int. Cl. H02H 5/04

(52) U.S. Cl. 361/103

(57) ABSTRACT

A protection circuit integral to a fast switching device is described. A voltage converter converts an input voltage to an output voltage. The voltage converter is provided with a first FET for repetitively switching on and off the input voltage (Vin) to generate the output voltage; a second FET for outputting a voltage while the first FET is off; a PWM controller for controlling the switching action of the first and second FETs; and a protection circuit driven by electric power supplied from the drain of the first FET and causing a short-circuit between the gate and the source of the first FET when the temperature in the first and second FETs rises above a predetermined value.

### FIELD OF THE INVENTION

The present invention relates to a method and apparatus for protecting a semiconductor switching device from overheating without introducing any delay while switching.

### BACKGROUND OF THE INVENTION

At present, synchronous rectification is fast becoming the most commonly used method for handling large capacity DC/DC conversion. They are characterized by their ability to introduce a high level of efficiency at very advantageous levels of heat generation. N-channel Field Effect Transistors (FETs) are used as both upper and lower switching FETs when they are supported by a PWM (Pulse Width Modulation) controller. Each of the switching FETs controls a plurality of carriers with an electrical field generated by the applied voltage to switch itself on and off. Such FETs are provided with a high input impedance. At present, MOS (Metal Oxide Semiconductor) FETs are the most commonly used in industry.

Typically, a large capacity DC/DC converter designed for notebook PCs, and the like, converts an input voltage of about 16V received from an AC adapter and an input voltage (Vin) of about 10V received from a battery to output a voltage (Vout) of about 1.6V to, e.g., a CPU. The electric power load of the CPU is significantly large (e.g., 15 A-20 A), forcing a rise in temperature of the FET. This becomes a significant problem, specially when a program makes the CPU operate faster, which in turn, makes the FET temperature rise sharply, exceeding the absolute rating temperature and introducing unwanted reliability problems which, ultimately, cause the FET to fail.

FIG. 10 shows a circuit diagram of a DC/DC converter for which an independent protection circuit 220 is employed. An output voltage (Vout) 203 is supplied on the basis of an input voltage (Vin) 201. Referring to the DC/DC converter, (FET1) 204 and (FET2) 205 act as switching FETs (upper leg FET and lower leg FET, respectively). FETs 204 and 205 are controlled by PWM controller 210. The protection circuit 220 senses any overheating in FET 204 and shuts down the operation of the DC/DC converter. This protection circuit 220 is also provided with a PTC (Positive Temperature Coefficient) 221, a resistor (R1) 222, and a transistor (TR1) 223. The PTC 221 is a thermal sensor that monitors the temperature of FET 204 or FET 205.

In the case when the temperature of FET 204 or FET 205 rises, the resistance value of the PTC 221 increases significantly, switching on transistor (TR1) 223. At this time, the +ON signal 224 switches to low, turning off and shutting down the PWM controller. Thermal sensor PTC 221 is conventionally used to protect the switching transistor from overheating and turns off the on/off control terminal of the DC/DC converter when an abnormally high temperature is detected. Consequently, FET 204 and the like, are protected from overheating.

Present art techniques, however, present a difficulty in the way how to position the thermal sensors (e.g., PTC 221) near the switching FETs (e.g., FET 204). Consequently, even when conventional protection circuit 220 is disposed in the most favorable location, a sensing error of about 20° C. arises in the temperature state of FET 204. In some cases, no abnormal state can be detected even when the absolute rating temperature of the switching FET is exceeded. In order to avoid this problem, as will be discussed hereinafter, the invention provides a built-in overheat shut-off circuit within the power MOSFET. For example, a gate resistor is positioned between the gate terminal of the power MOSFET and an external gate terminal, and a protection circuit MOSFET is provided at the gate terminal. In this manner, the protection circuit MOSFET is activated in direct response to overheating of the power MOSFET, wherein current flows through the gate resistor to lower the voltage at the gate terminal of the power MOSFET of the device body. Thus, the power MOSFET of the device body can be shut off. This conventional method, however, has been confronted with a problem that the gate resistance becomes so large that it shuts off the power MOSFET of the device body. Now, when the device is driven at high frequency, the gate delay time and the switching loss become significant.

In order to solve this problem, Japan Published Unexamined Patent Application No. 6-244414 and Japan Published Unexamined Patent Application No. 7-176733 disclose a technique for shutting off the power MOSFET of the device body by turning off the switching device or setting it to a high impedance when the power MOSFET of the device body overheats. The switching device configured by a MOSFET is disposed between the gate of the power MOSFET of the device body and an external gate. In accordance with the method of the present invention, a resistance component of about 2 KΩ is placed serially between the gate terminal of the power MOSFET of the device body and the external gate terminal, including also a capacitor. The switching speed is thus reduced to about 750 nsec. For example, at a switching speed of 50 nsec or less, about 30 nsec are expected for the switching device to be acceptable to the CPU to be considered fast switching. Because the resistance component affects the gate terminal, it causes switching to be delayed even when the resistance is as low as 1Ω to 2Ω. It is, thus, difficult to apply the technique disclosed to fast switching DC/DC converters.

### OBJECTS OF THE INVENTION

Accordingly, it is an object of the present invention to protect a switching device from overheating without adding resistance to the gate of the switching device and without affecting its performance.

It is still another object of the present invention to protect the switching device from overheating while the switching device is enabled for fast switching action even when no protection circuit is built in the switching device.

It is yet another object of the present invention to place the protection circuit in a reduced circuit area and having the protection circuit to be an integral part of the switching device to improve its switching action.

### SUMMARY OF THE INVENTION

In order to achieve the above objects, in a first aspect of the present invention, the temperature of the switching device in a voltage converter is detected, causing a short-circuit between the source and the gate of the switching device when the temperature rises. The overheat protection remains in place until the temperature falls below a predetermined value or until the power source is removed.

In another aspect of the invention, there is provided a switching device whose temperature rises as a function of its switching action. The protection circuit is powered from a first terminal of the switching device which short-circuits the second to the third terminal of the switching device when the switching device overheats.

The protection circuit leaves the performance of the circuit unaffected, and avoids having to restart the switching device as long as the temperature remains elevated following the short circuiting of the two terminals of the switching device.

The protection circuit protects the device from overheating by way of an apparatus provided with a temperature sensor which resistance varies as a function of temperature within the switching device. Moreover, the temperature hysteresis of the temperature sensor maintains the short-circuit between second and third terminals for a predetermined duration of time.

The switching device further provides a two-element device with overheat protection when the switching device is configured by an upper-leg first switching device and a lower-leg second switching device, with the protection circuit causing a short-circuit between second and third terminals of switching device.

The semiconductor module of the present invention provides a switching device with fast switching speed and a protection circuit that enables the fast switching speed by avoiding a serial positioning of any added resistance on the gate line of the switching device, bringing to a stop its switching action when the switching device overheats. When this occurs, the protection circuit causes a short-circuit between the source line and the gate line of the switching device, forcibly stopping the switching action in the switching device. The protection circuit is driven by electric power obtained from the drain line of the switching device. With such a configuration, the protection circuit prevents the switching performance from being affected and does not introduce any added resistance to the gate line.

When the protection circuit is configured as an integral part of the switching device (i.e., within one package, by incorporating the protection circuit into the semiconductor module), the protection circuit becomes compatible with the switching device lacking overheat protection.

### BRIEF DESCRIPTION OF THE DRAWINGS

FIG. 1 is a first embodiment of a DC/DC converter to which the present invention applies.

FIG. 2 shows a more detailed diagram of the protection circuit integrated within FET 20, in accordance with the present invention.

FIGS. 3(a)-3(b) are timing charts of the operation of the protection circuit.

FIG. 4 shows a second embodiment of the protection circuit 30 integrated with FET 20.

FIG. 5 shows a third embodiment of the protection circuit 30 built-in FET 20.

FIG. 6 shows a fourth embodiment of the protection circuit 30 built in the FET 20.

FIG. 7 is a circuit diagram of a second embodiment of the DC/DC converter of the present invention.

FIG. 8 shows an example of a two-element FET 40 with a protection circuit.

FIG. 9 shows the second example of the two-element FET 40 with a protection circuit.

FIG. 10 is a circuit diagram of a DC/DC converter for which a conventional protection circuit is employed.

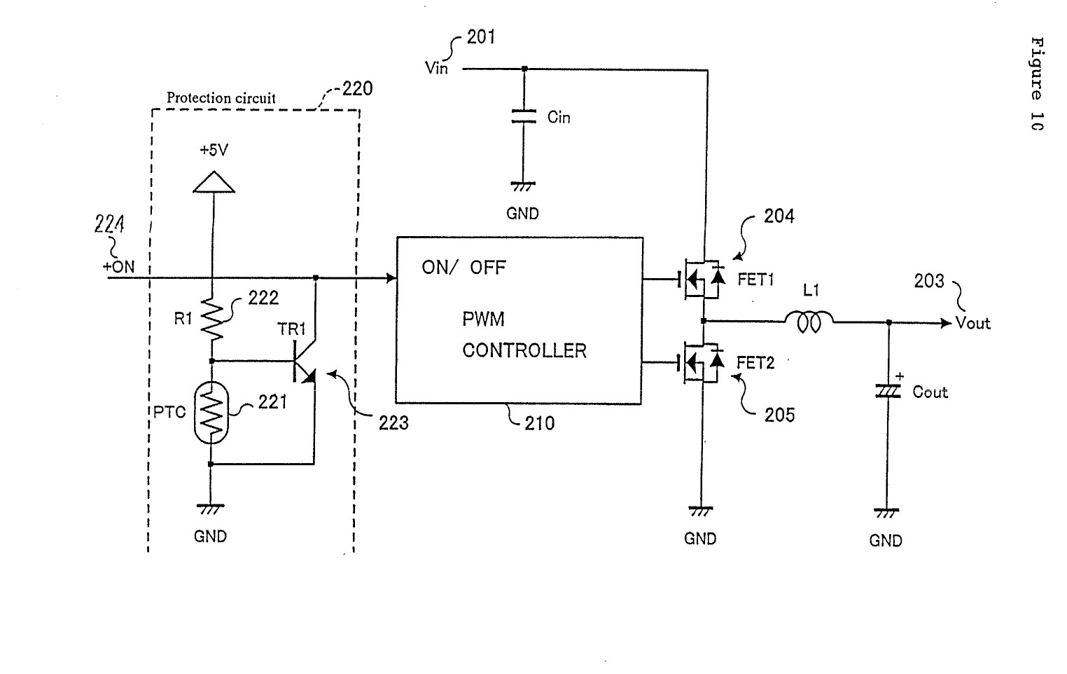

### DETAILED DESCRIPTION OF THE INVENTION

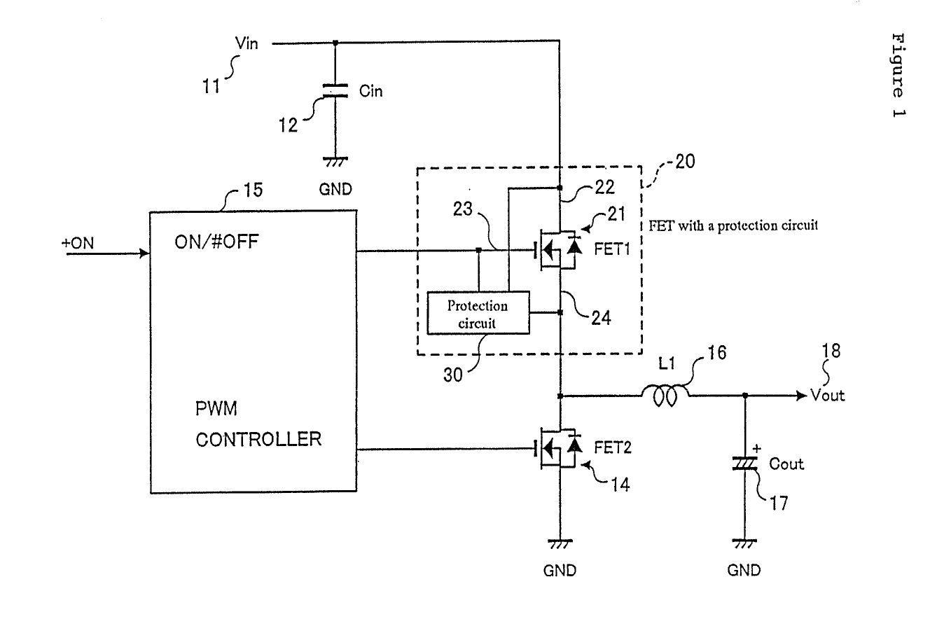

FIG. 1 illustrates a circuit diagram of a DC/DC converter in accordance with the present invention. The DC/DC converter, is shown for illustrative purposes only, as a voltage converter supplying voltage to, e.g., the CPU of a notebook PC. Because the CPU carries a large current load, similarly, the DC/DC converter must also be able to handle large currents. The switching device employed by the DC/DC converter is a fast switching device suited for high frequency applications (e.g., 300 kHz or over) for supplying electric power to the CPU.

In the present embodiment, a voltage of 16V is supplied to the DC/DC converter by an AC adapter (not shown) at input pin (Vin) 11. For illustrative purposes, the DC/DC converter is connected to a battery (not shown), supplying 10V to the DC/DC converter. The DC/DC converter is configured to supply an output voltage (Vout) 18 of about 1.6 V to the CPU (not shown), at a current between 16 A to 20 A. For the circuit configuration shown in FIG. 1, the DC/DC converter is provided with an input capacitor (Cin) 12; an FET 20 provided with a protection circuit, i.e., a semiconductor module provided with a first FET (FET1) 21—the upper-leg FET; a second FET (FET2) 14—the lower-leg FET; PWM controller 15 that controls FET 20 with the protection circuit and FET 14; a inductive coil (L1) 16; and an output capacitor (Cout) 17 for smoothing the electrical signals.

Input capacitor (Cin) 12 prevents the AC current from flowing to an input line and improves its synchronous rectification. The PWM controller 15 is activated when the POWER switch of the notebook PC switches on. PWM controller 15 controls the output voltage of FET 21 by changing the on/off ratio of FET 21. As long as first FET 21 remains on, output voltage (Vout) 18 supplies electric power to the load and accumulates electric power in coil (L1) 16. When FET 21 is turned off and FET 14 is turned on, the electric power accumulated in the coil (L1) 16 is supplied to the load.

FET 20 provided with a protection circuit consists of upper-leg FET 21, preferably, an N-channel type switching FET having a drain 22, a gate 23, and a source 24; protection circuit 30 driven by a voltage added to the drain 22 of FET 21 to short-circuit gate 23 to source 24 when abnormal overheating occurs. FET 21 and the protection circuit 30 are, preferably, integrated into one unit.

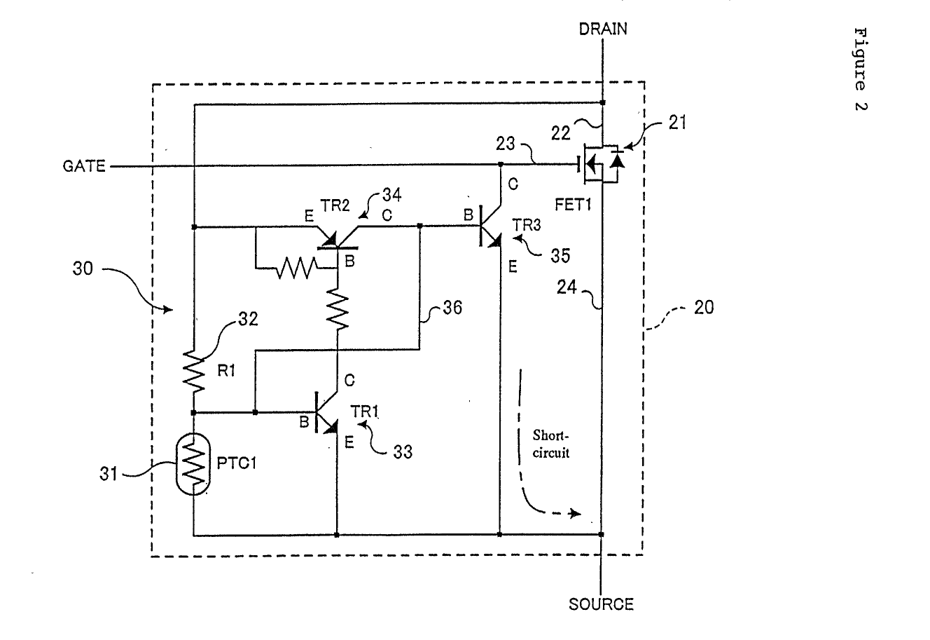

FIG. 2 shows a detailed description of protection circuit 30 built within FET 20 and its protection circuit. The protection circuit 30 is further provided with a PTC, namely, a positive temperature coefficient thermistor (PTC1) 31; resistor (R1) 32; and transistors (TR1) 33, (TR2) 34 and (TR3) 35. The collector of transistor (TR2) 34 is connected to the base of transistor (TR1) 33 via line 36. The protection circuit 30 is driven by a voltage provided to drain 22 of FET 21. PTC thermistor (PTC1) 31 is preferably manufactured using sintered material such as barium titanate, or the like, and its electric resistance rises with temperature. Because PTC thermistor (PTC1) 31 and FET 21 are concurrently manufactured within the same package, the electric resistance rises according to a temperature rise in FET 21. The collector of transistor (TR3) 35 is connected to the gate terminal 23 of FET 21, and the emitter of transistor (TR3) 35 to the source terminal 24 of FET 21.

The resistance of PTC thermistor (PTC1) 31 increases when the temperature of FET 21 rises. For example, when the voltage at the two ends of the PTC thermistor (PTC1) 31 becomes greater than that at resistor (R1) 32 by, e.g., 0.6 v, due to a temperature rise to at least 120° C., transistor (TR1) 33 switches on, which, in turn, turns on transistors (TR2) 34 and (TR3) 35. Transistor (TR3) 35 on causes a short-circuit between gate terminal 23 and source terminal 24 of FET 21. This short-circuit stops the switching action of FET 21. Since the collector of transistor (TR2) 34 is connected to the base of transistor (TR1) 33, transistor (TR1) 33 once turned on, remains on. This protection circuit 30 is activated normally at an abnormal time after the source terminal of FET 21 switches to GND.

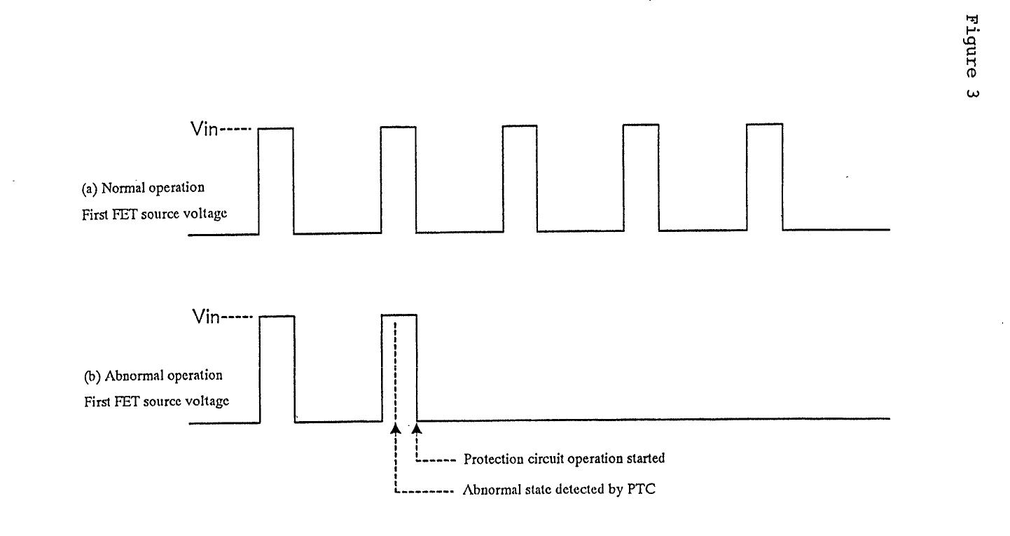

FIGS. 3(a) and 3(b) are timing charts illustrating the operation of protection circuit 30. FIG. 3(a) shows FET 21 (FIGS. 1 or 2) operating in normal mode. FIG. 3(b) shows an abnormal operation when FET 21 (FIGS. 1 or 2) generates heat. The horizontal axis and the vertical axis in each of FIGS. 3(a) and 3(b) denote, respectively, the time and output of the source voltage in FET 21. As shown in FIG. 3(a), when FET 21 operates normally, a voltage is outputted to the source of FET 21 concurrently with the switching action of FET 21 coinciding with the level of input voltage (Vin) 11. During an abnormal operation shown in FIG. 3(b), the protection circuit 30 is not activated even when the PTC thermistor (PTC1) 31 detects a high temperature while FET 21 is on (while the source voltage of FET 21 is at Vin). When FET 21 switches off and FET 14 switches on, the protection circuit 30 is activated and the switching action of FET 21 stops. When this occurs, the output of the DC/DC converter switches to low. When the output of the DC/DC converter is at a predetermined voltage, the PWM controller 15 activates the low-voltage protection circuit (not shown), shutting itself off. Consequently, both of the upper-leg FET 21 and the lower-leg FET 14 prevent the temperature from rising over a pre-specified value.

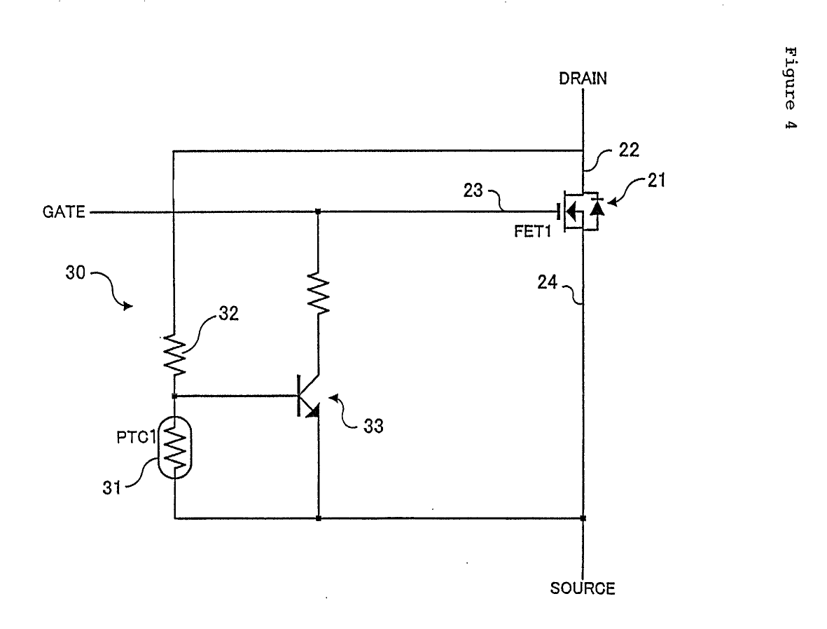

FIG. 4 shows a second embodiment of protection circuit 30. Just as in the previous example shown in FIG. 2, when the temperature of FET 21 rises, the resistance of PTC thermistor (PTC1) 31 increases, turning on transistor (TR1) 33. With transistor (TR1) 33 on, a short-circuit is established between gate terminal 23 and source terminal 24 of FET 21, stopping the switching action of FET 21. A short-circuit between the gate terminal 23 and the source terminal 24 is maintained until the temperature of PTC thermistor (PTC1) 31 falls. The output of the DC/DC converter drops, but the temperature hysteresis of the PTC thermistor (PTC1) 31 secures for a certain time until the short-circuit is reset. Thus, when protection circuit 30 is provided with PTC thermistor (PTC1) 31 having such temperature hysteresis characteristics that it can reset the overheating of FET 21 during this time, it is possible to resolve problems such as smoke, etc., caused by overheating of FET 21. According to the second example, protection circuit 30 can be simplified, reducing its manufacturing cost.

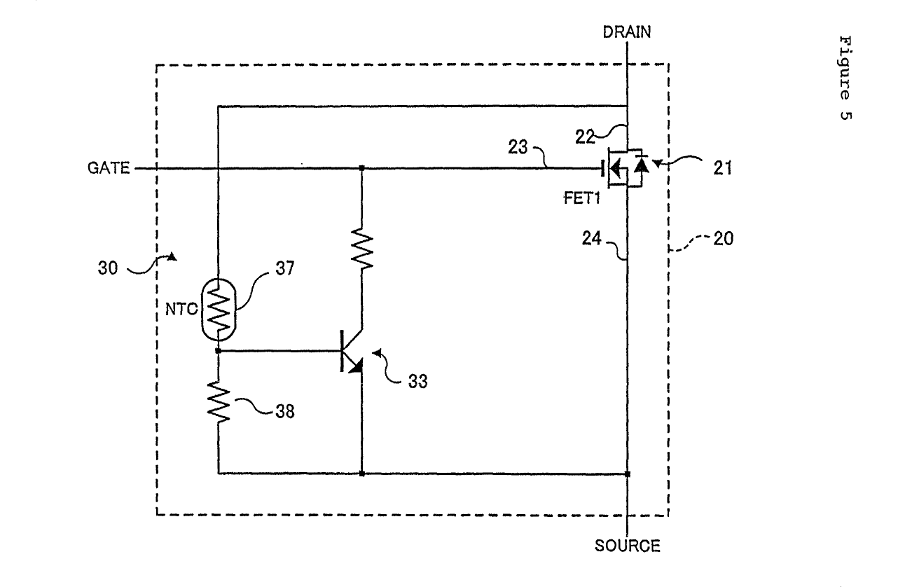

FIG. 5 shows a third embodiment of protection circuit 30 built-in FET 20 having a protection circuit. Protection circuit 30 is provided with an NTC (Negative Temperature Coefficient) thermistor (NTC) 37 whose electric resistance value is reduced according to a rise in temperature. In the normal state, the temperature of FET 21 remains low and the resistance value of the NTC thermistor (NTC) 37 is larger than that of resistor 38. When the temperature of FET 21 rises, the resistance of the NTC thermistor (NTC) 37 is reduced, and the voltage at both ends of the resistor 38 becomes larger (e.g., at least 0.6V) than that of NTC thermistor (NTC) 37. Consequently, transistor (TR1) 33 is turned on. A short-circuit then occurs between gate terminal 23 and source terminal 24 of FET 21. The switching action of FET 21 stops, and the output of the DC/DC converter drops until the temperature of the NTC thermistor (NTC) 37 falls. However, the temperature hysteresis of the NTC thermistor (NTC) 37 secures for a certain time until the short-circuit is reset.

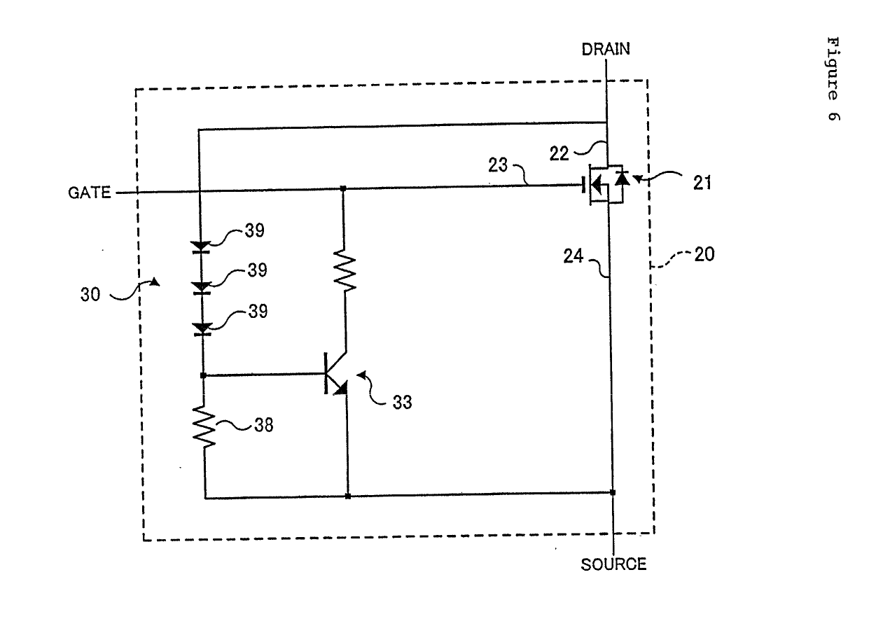

FIG. 6 shows a fourth embodiment of protection circuit 30. Herein, protection circuit 30 is provided with a plurality of diodes 39 instead of temperature sensors such as NTC thermistor (NTC) 37, etc., shown in FIG. 5. The temperature characteristics of diodes 39 reduces the voltage Vf in the forward direction of the diodes when the temperature rises. Because one diode 39 alone is insufficient, three serially connected diodes are preferably used. Just as in previous configurations, one may let the output of the DC/DC converter drop when the temperature in FET 21 rises, thus avoiding overheating problems. Although not shown in FIG. 6, it is also possible to achieve the same effect by using the temperature dependency of a bipolar transistor (i.e., by reducing the voltage Vbe between base and emitter when the temperature rises).

According to the present embodiment, one may control the temperature on the three terminals of a MOSFET (drain 22, gate 23, and source 24) as seen in FET 21. FET 20 having the protection circuit 30 may be built using a discrete MOSFET, which is used in conjunction with the conventional MOSFET. As a result, the protection circuit 30 can be designed more freely by providing an FET without an overheat protection function in the design stage and replacing the FET with another having a protection circuit.

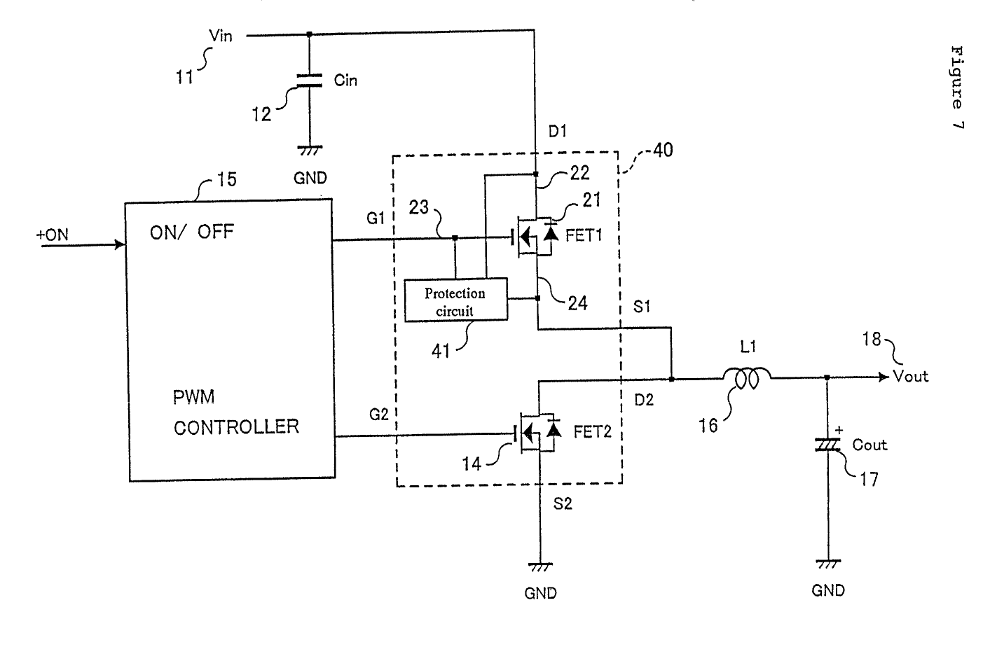

While a device having an N-channel device is provided with a protection circuit 30 in the previous, such a protection circuit can also be provided for a device with two N-channel elements, as will be described hereinafter with reference to FIG. 7.

FIG. 7 shows a circuit of a DC/DC converter, wherein FET 21 is an N-channel type upper-leg switching FET and FET 14 is an N-channel type lower-leg switching FET. The package is provided with protection circuit 41 to configure a two-element FET 40 with protection capabilities. As previously described, the two-element FET 40 with protection is controlled by PWM controller 15 to secure fast switching.

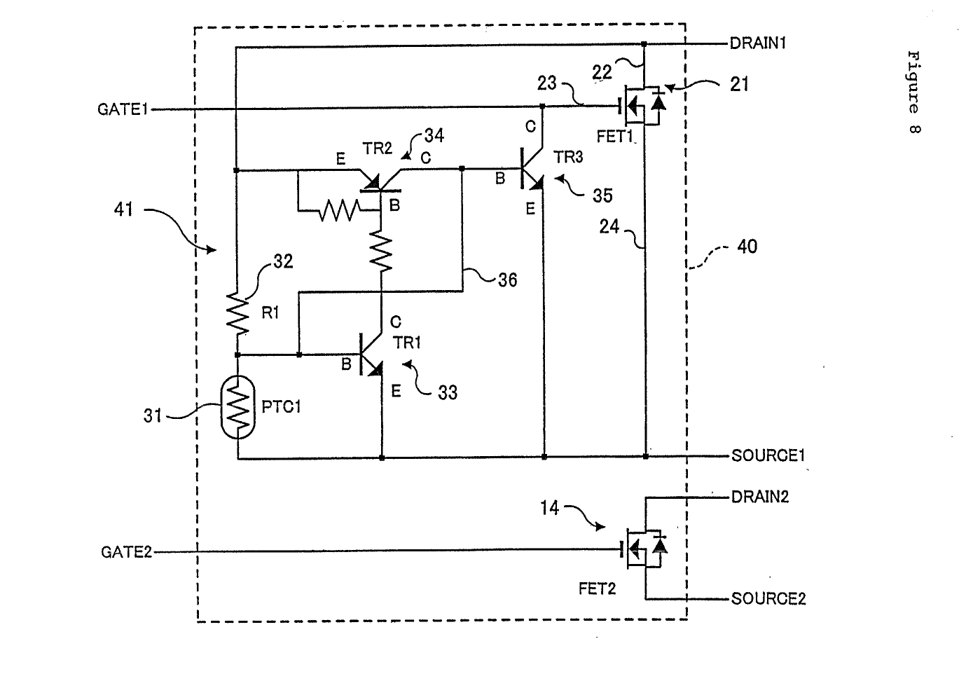

FIG. 8 shows the two-element FET 40 with the protection circuit. The two-element FET is provided with two sets of terminals (gate, source, and drain). Protection circuit 41 is connected to drain 22, gate 23, and source 24 of FET 21. The configuration of this protection circuit 41 is identical to that of protection circuit 30 shown in FIG. 2. The resistance of PTC thermistor (PTC1) 31 increases when FETs 21 and 14 become overheated, turning on transistor (TR1) 33, transistor (TR2) and transistor (TR3) 35. When transistor (TR3) 35 switches on, a short-circuit between the gate 23 and the source 24 of FET 21 takes place, and the switching action of FET 21 is stopped. As in FIG. 2, the device is provided with a protection function, thereby transistor (TR1) 33 remains on via line 36.

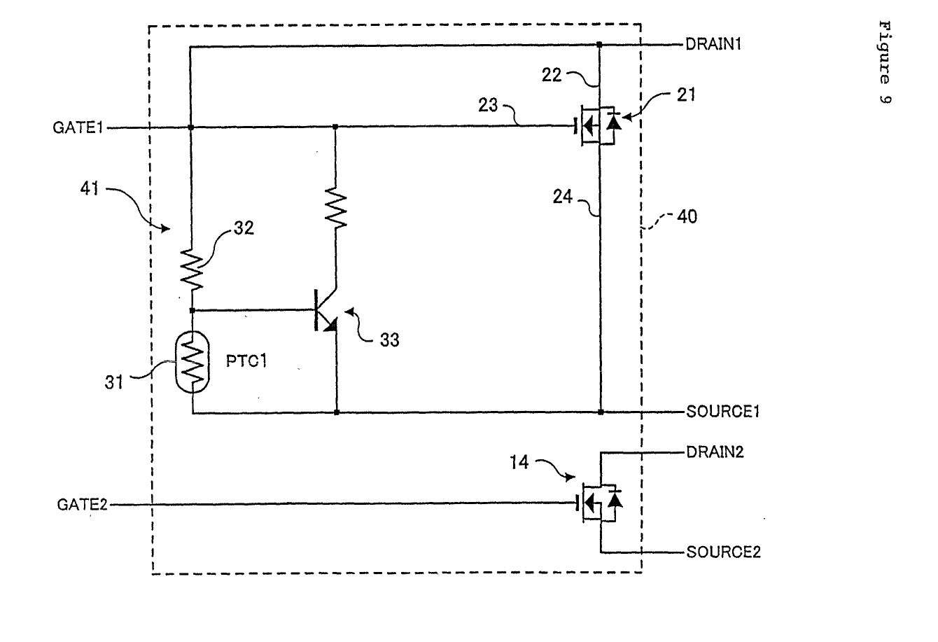

FIG. 9 shows a second example of the two-element FET 40 with a protection circuit. The configuration of the protection circuit 41 provided in the two-element FET 40 is identical to that of protection circuit 30 in the example shown in FIG. 4. The resistance of PTC thermistor (PTC1) 31 increases when FETs 21 and 14 become overheated, turning on transistor (TR1) 33. When this occurs, a short-circuit occurs between gate 23 and source 24 of FET 21, stopping the switching action of FET 21. The short-circuit between gate 23 and source 24 is kept until the temperature of the PTC thermistor (PTC1) 31 drops sufficiently, at which time the output of DC/DC converter also falls. In the second example shown in FIG. 9, the temperature hysteresis of the PTC thermistor (PTC1) 31 secures a recovery time to protect the device from overheating. No special mechanism is employed herein to keep the protection mechanism configured by line 36, transistors (TR2) 34 and (TR3) 35, and the like, shown in FIG. 8. Consequently, the device configuration can be simplified and the manufacturing cost reduced.

In the present embodiment, the two-element FET 40 with a protection circuit is configured by having an overheat protection circuit 41 built in a two N-channel-element device that includes FETs 21 and 14. Consequently, the protection circuit 41 can be disposed very close not only to FET 21, but also to FET 14, protecting the device from overheating in FETs 21 and 14.

As described above, according to the various embodiments of the present invention, electric power for driving the protection circuit 41 is supplied by drain 22. The operation of protection circuit 41 causes a short-circuit between gate 23 and source 24. Consequently, only signals from the source and the drain are required for the protection circuit 41, allowing the protection circuit to be advantageously built within the FET package. Accordingly, a temperature rise in the FET can be immediately known and resolved. In addition, the circuit area is significantly reduced, lowering the manufacturing cost. Since only the source, gate, and drain signals are used to configure the overheat protection circuit, it can be expected that the protection circuit to be fully integrated in the future in FET packages such as an intelligent MOSFET and the like. Furthermore, since none of the resistors and FETs are connected to the gate line serially when the protection circuit is built in the FET package, i.e., since there is no resistive component added at gate 23, FET 21 can used for fast applications. Furthermore, because drain 22 supplies the electric power of the protection circuit 41, it may latch the protection state after performing its protection function, thereby the protection circuit 30, 41 can protect the device properly from overheating to occur in the FET.

While this embodiment has been described on the assumption that the protection circuit 41 is built in the FET package, the technique also applies to other embodiments in which the protection circuit 41 is separate from the FET package. A protection circuit provided outside the FET can be configured to stop the switching action of the FET by causing a short-circuit between gate 23 and source 24 while avoiding placing resistive components on the gate 23 line and having electric power received from drain 22. This configuration is excellent in that the FET is enabled for fast switching, and the protection circuit 41 can be reduced in size. This invention can be realized using not only such FETs, but with other switching devices, such as a bipolar transistor and the like.

As described above, according to the present invention, since the protection circuit is built within the switching device, it is possible to solve the conventional problems of how and where to place the protection circuit to reduce the circuit area. Furthermore, it is possible to protect the switching device from overheating without employing any resistive component at the gate of the switching device, thereby speeding the switching action.

We claim:

1. A semiconductor module comprising:
a three terminal switching device whose temperature rises as a function of its switching activity; and
a protection circuit connected to said switching device, short-circuiting two of said three terminal of said switching device when the temperature in said switching device rises above a predetermined level, said short circuit causing the temperature in said switching device to drop.

2. The semiconductor module according to claim 1,
wherein said protection circuit controls the duration for maintaining said short-circuit between said second terminal and said third terminal.

3. The semiconductor module according to claim 1,
wherein said protection circuit includes a temperature sensor comprising a resistor whose resistance varies according to the temperature in said switching device, said temperature sensor being provided with temperature hysteresis that determines the duration for maintaining said short-circuit between said terminals of said switching device.

4. The semiconductor module according to claim 1,
wherein said switching device includes a first and a second switching element, said protection circuit causing a short-circuit between two terminals of said first switching element.

5. A semiconductor module, comprising:
a switching device; and
a protection circuit enabling and disabling the switching action of said switching device, said protection circuit inhibiting said switching device from switching when said switching device is overheated.

6. The semiconductor module according to claim 5;
wherein said switching device is a field-effect transistor provided with source, a drain and a gate, said protection circuit causing a short-circuit between said source and said gate of said switching device, stopping the switching action of said switching device when a predetermined temperature rise is detected in said switching device.

7. The semiconductor module according to claim 5,
wherein said protection circuit is driven by electric power at said drain of said switching device.

8. The semiconductor module according to claim 5,
wherein said protection circuit is devoid of resistive elements coupled to the gate of said switching device.

9. A fast switching device, comprising:
a drain coupled to an input power source;
a gate devoid of resistive elements serially connected to said gate; and
a source for outputting a current, wherein said gate and said source are electrically shorted to each other when an abnormal overheating temperature is detected.

10. The semiconductor module according to claim 9, further comprising:
a sensor whose electric resistance varies according to a temperature rise; and
means for causing a short-circuit between said gate and said source in response to said sensor, wherein said drain supplies electric power to drive said sensor and said transistor.

11. A protection circuit for protecting an FET (Field Effective Transistor) from overheating, comprising:
an input connected to the drain of said FET for powering itself;
a switching element responsive to the temperature of said FET and detecting when said temperature reaches a predetermined value; and
a means for creating a short-circuit between the gate and the source of said FET to inhibit further switching action of said FET.

12. The protection circuit according to claim 11,
wherein said switching element includes a temperature sensor whose electric resistance value varies according to a temperature rise; and
a transistor responsive to changes of said electric resistance of said temperature sensor.

13. The protection circuit according to claim 11, further comprising means for maintaining a switching action by said FET.

14. A protection circuit for protecting an FET from overheating, comprising:
a resistor being connected to a drain line of said FET;
a thermal sensor whose resistance value rises according to a temperature rise in said FET; and
a transistor switching on as a function of resistance in said thermal sensor, said protection circuit causing a short-circuit between a gate and a source of said FET when said FET is switched on.

15. A voltage converter for converting an input voltage in order obtain an output voltage, comprising:
a first switching device that turns on and off said input voltage repetitively, thereby outputting a voltage;
a second switching device that supplies electric power while said first switching device is off;
a controller for controlling said switching actions of said first and second switching elements; and
a protection circuit being driven by said electric power supplied from the drain of said first switching device and causing a short-circuit between the gate and the source of said first switching device when said first switching device or said second switching device reaches a predetermined temperature.

16. The voltage converter according to claim 15,
wherein said protection circuit is built as an integral part of said first switching device or of said first and second switching elements.

17. The voltage converter according to claim 15,
wherein said controller activates a built-in voltage protection circuit to stop its operation when said output voltage drops below a predetermined voltage.

18. A voltage converter that converts an input voltage to a output voltage with capability of supplying large current, comprising:
a switching device for turning on and off said input voltage repetitively in order to generate said output voltage;
a controller for controlling said switching device; and
a protection circuit for enabling a fast switching action in said switching device by avoiding a serial positioning of resistive components on the gate of said switching device, and for stopping the switching action of said switching device prior to said switching device becoming overheated.

19. The voltage converter according to claim 18, wherein said protection circuit inhibits said switching action of said switching device.
